(19) United States
(12) Patent Application Publication
(10) Pub. No.: US 2021/0205928 A1
(43) Pub. Date: Jul. 8, 2021

(54) POWDER BED FUSION APPARATUS

(71) Applicant: RENISHAW PLC, Wotton-under-Edge, Gloucestershire (GB)

(72) Inventors: David Edward BEEBY, Wotton-under-Edge (GB); David John Whitton, Bristol (GB); Andrew Thomas CRITCHLEY, Haresfield (GB)

(73) Assignee: RENISHAW PLC, Wotton-under-Edge, Gloucestershire (GB)

(21) Appl. No.: 16/755,870

(22) PCT Filed: Oct. 19, 2018
(86) PCT No.: PCT/GB2018/053022

§ 371 Date: Apr. 13, 2020

(30) Foreign Application Priority Data
Oct. 23, 2017 (EP) 17197696.2

(51) Int. Cl. B23K 26/342; B23K 26/04; B23K 26/082; B23K 26/12; B23K 26/144; B23K 26/14; B23K 26/16; B23K 26/70; B22F 10/28; B22F 12/70; B22F 10/73; B33Y 30/00; B33Y 40/00

(52) U.S. Cl. CPC B23K 26/342; B23K 26/04; B23K 26/082; B23K 26/127; B23K 26/144; B23K 26/1464; B33Y 40/00; B23K 26/702; B22F 10/28; B22F 12/70; B22F 10/73; B33Y 30/00; B23K 26/16

(57) ABSTRACT

A powder bed fusion apparatus including a build chamber, a build platform in the build chamber for supporting a powder bed, a layer formation device for forming layers of powder to form the powder bed, a scanner for scanning an energy beam across the powder bed to fuse the powder and a gas circuit for forming a gas flow across the powder bed. The gas circuit includes a separator for separating particles from gas in the gas circuit, a nozzle for propelling gas into the build chamber and an exhaust for extracting gas from the build chamber and delivering the gas to the separator. The exhaust includes an exhaust channel or opening located for receiving powder wiped from the powder bed and/or build platform.

### FIELD OF INVENTION

This invention concerns powder bed fusion apparatus and, in particular, but not exclusively, powder bed fusion apparatus in which a laser is used to consolidate powder of a powder bed in a controlled, typically inert, atmosphere.

### BACKGROUND

Powder bed fusion apparatus produce objects through layer-by-layer solidification of a material, such as a metal powder material, using a high energy beam, such as a laser or electron beam. A powder layer is formed across a powder bed contained in a build sleeve by lowering a build platform to lower the powder bed, depositing a heap of powder adjacent to the lowered powder bed and spreading the heap of powder with a wiper across (from one side to another side of) the powder bed to form the layer. Portions of the powder layer corresponding to a cross-section of the workpiece to be formed are then solidified through irradiating these areas with the beam. The beam melts or sinters the powder to form a solidified layer. After selective solidification of a layer, the powder bed is lowered by a thickness of the newly solidified layer and a further layer of powder is spread over the surface and solidified, as required. An example of such a device is disclosed in U.S. Pat. No. 6,042,774.

A problem posed by such devices is how to recover powder that is not consolidated for a subsequent build. There are three sources of unconsolidated powder from a build. First, the impact of the laser with the powder bed can cause powder to be ejected from the powder bed. Typically, a gas knife is provided across the powder bed and at least some of this ejected powder is carried away by the gas knife to a gas exhaust. Secondly, to form each layer it is usual to dose more than the required amount of powder to form a layer (a “better safe than sorry” approach). However, this leads to the presence of excess powder at the end of each layer formation.

Typically, this excess powder is pushed into a powder overflow channel and collected in a container. The excess powder can amount to a significant proportion of the total powder used for a build. The third source of unconsolidated powder is unconsolidated powder of the powder bed, which is recovered at the end of the build in a de-building process.

In Renishaw's RenAM™ 500 machine, the unconsolidated powder of the powder bed is recovered by raising the build platform and pushing the unconsolidated powder into the overflow channel. This powder together with the excess powder collects in a lower hopper. A pneumatic powder transport mechanism is provided to transport the powder from the lower hopper to an upper hopper for further dispense into the build chamber.

EP 2 992 942 A1 discloses apparatus comprising a cyclone separator for removing particulate impurities from the gas stream. The cyclone separator is used to reduce the particle load of the gas stream supplied to a downstream filter system. A majority of raw material powder present in the gas stream can be removed using the cyclone separator. The downstream filter system then can be operated to mainly filter process emissions such as, for example, welding spatter and nanoparticles formed by vaporisation of the powder material.

DE 10 2015 213 165 A1 discloses apparatus comprising a protective gas recovery device comprising a centrifugal separator for separating particles out of the gas stream. The protective gas recovery device can be connected to a powder recovery device in the manner shown in in EP 2 052 845 A2. EP 2 052 845 A2 discloses using an exhaust of a protective gas circuit for extraction of any smoke that may occur during the construction process. The exhaust can be manually guided close to the powder at the end of the construction process to suck powder from the process space. The powder recovery device may comprise, instead of a collecting container, a powder conveyor system, which feeds the powder back to the process space or the corresponding discharge device. The powder conveying system may be a conveyor screw.

### SUMMARY OF INVENTION

According to a first aspect of the invention there is provided a powder bed fusion apparatus comprising a build chamber, a build platform in the build chamber for supporting a powder bed, a layer formation device for forming layers of powder to form the powder bed, a scanner for scanning an energy beam across the powder bed to fuse the powder and a gas circuit for forming a gas flow across the powder bed, the gas circuit comprising a separator for separating particles from gas in the gas circuit, a nozzle for propelling gas into the build chamber and an exhaust for extracting gas from the build chamber and delivering the gas to the separator.

The exhaust may comprise an exhaust channel or opening located in the build chamber for receiving powder displaced from the powder bed. In one embodiment, the exhaust channel or opening may be located for receiving powder conveyed by mechanical means from the powder bed and/or build platform. For example, the exhaust channel or opening may be located for receiving powder wiped from the powder bed and/or build platform (for example by a wiper or a brush).

In other embodiment, the exhaust channel or opening may be located for receiving powder conveyed in other manners. For example, the apparatus may comprise a device for vibrating a surface of the build chamber to convey the powder towards the exhaust channel or opening, or the channel or opening exhaust may be located such that powder displaced from the powder bed falls and/or flows into the exhaust channel or opening.

The exhaust channel or opening may be located to receive powder conveyed along a surface, such as a surface of the powder bed and/or a surface surrounding the powder bed.

In this way, powder, such as excess powder dosed during layer formation or powder of the powder bed recovered during a de-build of the object can be recovered to the gas circuit without having to move the exhaust. In this regard, the exhaust channel or opening may have a fixed location in the build chamber.

The layer formation device may be arranged to form layers of powder in a working plane and the exhaust channel or opening may be located at or below the working plane. In this way, the powder does not need to be lifted for recovery into the exhaust.

The apparatus may comprise non-pneumatic means, for example, mechanical means, for conveying the powder to the exhaust channel or opening. For example, the layer formation device may comprise a wiper for spreading each layer and the exhaust channel or opening may be located such that the wiper pushes the powder (excess powder or powder recovered during a de-build) into the exhaust channel or opening. The wiper may move in a direction perpendicular to the gas flow through the build chamber. The at least one exhaust channel or opening may be located to be on a side of the powder bed to which the wiper pushes the powder. The exhaust may comprise two exhaust channels or openings (a first exhaust channel or opening and second exhaust channel or opening) one either side of the powder bed.

The exhaust may comprise an opening that extends above the powder bed for generating the gas flow across the powder bed.

Other non-pneumatic means may be provided for conveying the powder to the exhaust, such as a vibration device, as described above.

The exhaust may be arranged such that a significant proportion, if not a majority or substantially all, of the powder displaced from the powder bed that is not entrained in the gas flow is conveyed to the exhaust by the non-pneumatic means.

A bottom of the exhaust channel may be angled relative to the horizontal such that powder flows along the exhaust channel to be carried away by the gas flow in the gas circuit. The angle may be greater than an angle of repose of the powder.

The layer formation device may comprise a hopper from which powder is dosed in a controlled manner to be formed into the layers, for example, by being spread by a wiper. The separator may be located above the hopper such that powder falls from the separator into the hopper. For the avoidance of doubt, such an arrangement may be provided in addition to or independently from a location of the exhaust channel or opening in the build chamber. The hopper may be arranged to dose powder into the build chamber from above the working plane and powder is conveyed from the exhaust up to the separator by the gas flow. In this way, the gas flow may act, in the build chamber, as a gas knife for maintaining the atmosphere in the build chamber free from gas borne particles and, in the gas circuit, as a powder conveyor for conveying the powder to a location for subsequent dispense. Accordingly, a powder conveying system separate from the gas circuit for generating the gas knife may not be required.

The separator may comprise a cyclone separator. A cyclone separator has been found to be capable of separating a majority of micron sized powder from a gas flow, such as particles having a diameter of 10 microns or more. It is desirable to recover such micron sized particles for subsequent builds. It may be desirable that smaller particles, such as those below 10 microns, are separated from the larger particles. It has been found that smaller particles are not separated from the gas flow using a cyclone and remain entrained in the gas flow leaving the cyclone. The gas circuit may comprise a further filter, such as a mesh type filter, for separating these smaller particles from the gas flow.

The apparatus may comprise an end effector in the build volume to pick the object up and elevate it above the build platform. This may free powder from the object and allow the wiper or the operator to brush powder from the build platform during a de-build process. The mechanical manipulator may be capable of inverting the object above the build platform. This may facilitate the removal of powder from the object. The mechanical manipulator may be in accordance with the mechanical manipulator described in WO2018/154283, which is incorporated herein by reference.

The apparatus may comprise a collection hopper for collecting powder wiped from the powder bed and/or build platform into the exhaust. The collection hopper may comprise a gas outlet in an upper section thereof and a powder outlet below the gas outlet. A gas conduit may be connected to the gas outlet for transporting gas back to the nozzle. The powder outlet may be arranged to feed powder into the gas conduit such that the powder is entrained in the gas flow and transported to the separator. The powder outlet may comprise a valve for controlling the rate of powder flow into the gas conduit. The valve may be operated by a controller of the additive manufacturing apparatus, for example based on an upstream demand for powder or a blockage/back-up of powder detected upstream.

According to a second aspect of the invention there is provided a method of building an object using a powder bed fusion apparatus according to the first aspect of the invention, the method comprising recirculating gas through the build chamber and, during recirculating of the gas, forming a layer of powder from a dose of powder, wherein excess powder of the dose is delivered into the gas flow to be carried to the separator by the gas flow in the gas circuit.

According to a third aspect of the invention there is provided a method of building an object using a powder bed fusion apparatus according to the first aspect of the invention, the method comprising recirculating gas through the build chamber and, during recirculation of the gas, breaking out the object from the powder bed, wherein powder of the powder bed is mechanically delivered to the exhaust channel or opening to be carried to the separator by the gas flow in the gas circuit.

In addition to a proportion of the powder being mechanically delivered to the exhaust channel or opening, the gas flow between the nozzle and exhaust during breaking out of the object from the powder bed may deliver powder to the exhaust. For example, the method may comprise increasing a velocity of the gas flow during breaking out the object from the powder bed. The increased velocity of gas flow may act to pick-up/blow powder from a surface of the apparatus and/or object and carry the powder to the exhaust. During the additive manufacturing process, it is desirable to keep the gas velocity below a threshold such that a significant quantity of powder is not picked-up/blown from the powder bed by the gas flow. However, during breaking out of the object, this limitation no longer applies and the gas velocity can be increased above this threshold. Accordingly, the gas flow can act as a jet to dislodge powder from the powder bed and/or object.

The methods of the second and third aspects of the invention may comprise transporting the powder using the gas flow in the gas circuit to the separator located above the working plane.

According to a fourth aspect of the invention there is provided a powder transport system comprising a gas circuit comprising a gas conduit pipe, a powder hopper and a feeding device for feeding powder from the powder hopper into the gas conduit pipe such that gas flow in the powder conduit transports the powder along the gas circuit, wherein the feeding device comprises a feeding tube that extends into the gas conduit pipe such that an outlet of the feeding tube is located spaced from a sidewall of the conduit pipe.

The collection hopper and feeding tube may be arranged to gravity feed the powder into the conduit pipe.

The outlet of the feeding tube may be arranged such that, without gas flow, powder builds-up in the conduit pipe below the outlet to block the outlet to further powder flow without blocking a full cross-section of the conduit pipe. In this way, gas is not prevented from flowing through the conduit pipe by the powder fed into the conduit pipe.

According to a fifth aspect of the invention there is provided a device for controlling powder flow from a hopper comprising a feeding channel connected to the hopper such that powder can flow under gravity through the tube from the hopper, a lower member having a surface located below and spaced from the feeding channel for receiving powder exiting the feeding channel, the surface arranged such that powder can form a heap on the surface and, if not transported away, the heap will block an open end of the channel, and a transport device for generating a motive force for carrying away powder from the surface.

In this way, the device automatically controls the flow of powder from the hopper, based upon whether the motive force is carrying the powder away to maintain the channel unblocked.

The transport device may comprise a gas circuit comprising a pump for generating gas flow over the surface to transport the powder away for the surface. Alternatively, the transport device may comprise a vibrator, such as an ultrasonic vibrator, for vibrating the surface to cause the powder to flow across the surface to an outlet port.

The device may comprise a plurality of such feeding channels. The or each feeding channel may be provided in an upper member that is located above and spaced from the lower member. The lower member may comprise one or more outlets into which the powder to transported by the motive force. The outlets may be arranged such that gravity causes the powder to exit through the outlets once the powder has been transported to the outlets by the motive force.

### DESCRIPTION OF THE DRAWINGS

FIG. 1 is a schematic view of a powder bed fusion apparatus according to an embodiment of the invention;

FIG. 2 is a perspective view of the powder bed fusion apparatus shown in FIG. 1;

FIG. 3 is a schematic view of a powder bed fusion apparatus according to a further embodiment of the invention;

FIG. 4 is a perspective view of the powder bed fusion apparatus according to the further embodiment, wherein the build chamber door is omitted to show the inside of the build chamber;

FIG. 5 is a cross-sectional view of the powder bed fusion apparatus according to the further embodiment with arrows showing the general direction of gas flow in the build chamber;

FIG. 6 is a perspective view of an inside of a gas manifold/powder collection hopper of the powder bed fusion apparatus according to the further embodiment;

FIG. 7 is a perspective view of the powder bed fusion apparatus according to the further embodiment showing the inside of a gas manifold/powder collection hopper and part of the gas/powder transport circuit; and

FIG. 8 is a perspective view of feed pipe and control valve for feeding powder from the gas manifold/powder collection hopper into pipework of the gas/powder transport circuit.

### DESCRIPTION OF EMBODIMENTS

Referring to the Figures, a powder bed fusion apparatus 101 according to one embodiment of the invention comprises a build platform 102 movable within a build sleeve 103 to define a build volume, a layer formation device for forming layers of powder across the build volume in a working plane and a scanner 106 for directing a laser beam through an optical window 107 and steering the laser beam across the working plane to selectively fuse the powder. Successive formation of powder layers forms a powder bed 123 in the build volume.

The layer formation device typically comprises a doser 108 for dosing powder and a wiper 109 for spreading the dosed powder into a layer. In this embodiment, the doser is a top-doser, which doses powder from a hopper 110 onto surface 104. The doser 108 may be in accordance with that disclosed in WO2010/007396. A lower edge of the wiper defines the working plane and is substantially aligned with the surface 104.

A build chamber 113 is provided for maintaining an inert atmosphere surrounding the working surface of the powder bed. The build chamber 113 may comprise an upper and lower chamber as described in WO2010/007394. A gas circuit 116 is in fluid communication with the build chamber 113 via gas nozzle 114 and gas exhaust 115. A pump 117 pumps gas around the circuit such that gas nozzle 114 propels gas into the build chamber 113 and gas exhaust 115 extracts gas from the build chamber 113 to generate a gas flow (so called “gas-knife”) across the working plane. The gas circuit further comprises a separator 119 in the form of a cyclonic device for removing particles having a defined size, for example greater than 10 microns, from the gas flow and a fine mesh filter 120 for filtering particles having a size less than the defined size, for example the order of a few microns or less. Typically, particle size distributions for powder to be used in a metal powder bed fusion process will include particles between 10 and 100 microns and the cyclone separator 118 separates out particles having a size acceptable for a build from particles having a size below a lower size threshold for the build process.

The cyclone separator 119 is provided above the hopper 110 such that particles separated out from the gas flow by the cyclone separator 119 can fall into hopper 110. A sieve 121 is provided between the outlet from the separator 119 and the hopper 110, the mesh size of the sieve 121 selected such that particles below an upper size threshold fall therethrough into hopper 110 whilst particles larger than the upper size threshold migrate to an edge of the sieve 121 and fall into over-sized particle container 122. The particles returned to hopper 110 can then be re-dosed for the current or a subsequent build.

The powder bed fusion apparatus further comprises a mechanical manipulator 105 arranged to engage with a build substrate 102a, to which the object is attached, to tilt the object in a raised position above the working plane such that powder is freed from the object and deposited at a location above the working plane and into the build volume. The mechanical manipulator may be as described in WO2018/154283.

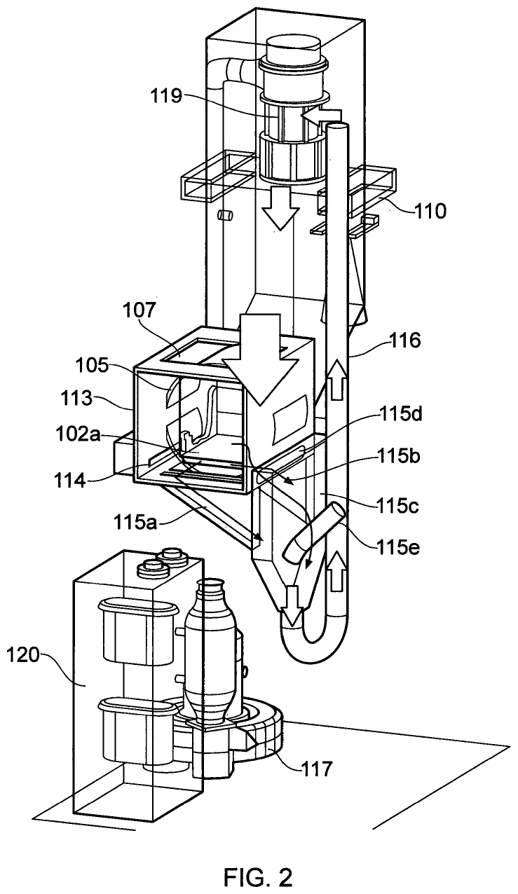

FIG. 2 shows a preferred positioning for the elements of the powder bed fusion apparatus. The hopper 110, doser 108 and wiper 109 are arranged such that powder is spread across the powder bed 123 in a layer formation direction perpendicular to the gas knife generated by gas nozzle 114 and gas exhaust 115. In FIG. 2 only some of the pipework of the gas circuit 116 is shown. FIG. 2 also illustrates overflow channels 115a and 115b of the gas exhaust 115, which are located either side of the powder bed 123 in the layer formation direction. These channels open out into the build chamber 113 and excess powder that is left over after a formation of a layer is pushed into the channel(s) 115a, 115b by the wiper 109. A bottom of each channel 115a, 115b is at an angle to the horizontal that is greater than an angle of repose of the powder. In this way, powder that is pushed into the channels 115a, 115b flows to an exhaust manifold/powder collection hopper 115c. However, it is believed that gas bleeding down the exhaust channels 115a, 155b will facilitate the flow of powder along the channels 115a, 115b and, accordingly, shallower angles for the bottoms of the exhaust channels 115a, 115b may be acceptable.

The exhaust manifold/powder collection hopper 115c is also connected with the build chamber 113 via an opening 115d provided above the working plane such that the gas knife is generated across the working plane from the gas nozzle 114 to the opening 115d in the gas exhaust 115.

Also shown in FIG. 2 is a build substrate 102a located above the working plane. Objects built in a powder bed fusion apparatus, particularly metal objects, are built on a build substrate 102a mounted on the build platform 102, as disclosed in U.S. Pat. No. 5,753,274. The mechanical manipulator 105 may be arranged to engage with the build substrate to lift the build substrate and the object connected thereto above the working plane, sufficient clearance being provided for the wiper 109 to travel underneath. Accordingly, on completion of a build, the mechanical manipulator 105 is rotated to locate engagement arms 105a, 105b such that raising of the object and the build substrate 102a to the position shown in FIG. 2 causes the arms to engage with the build substrate 102a and secure the build substrate 102a to the mechanical manipulator 105. The build platform 102 is then lowered and further rotation of the mechanical manipulator 105 raises the build substrate 102a and the object 124 attached thereto to above the working plane. During this process, the object 124 is freed from the powder of the powder bed 123, this powder falling back into the build volume, on the surfaces around the build volume or into overflow channels 115a, 115b. Powder remaining in the build chamber 113 is then recovered by pushing the powder in to the overflow channels 115a, 115b using the wiper 109. This may be carried out in conjunction with staged raising of the build platform to control an amount of powder that is available for the wiper 109 to push into the channels 115a, 115b on each stroke.

In addition, a velocity of the gas knife may be increased during the de-build by appropriate control of the pump 117 to facilitate removal of powder from the object 124. The mechanical manipulator 105 may be further rotated and carry out sudden halts to knock/vibrate powder from the object and to pass the object through the gas knife at different orientations.

The recovered powder is conveyed to the cyclone separator 119 through the gas circuit 116 by the gas flow, the cyclone separator separating powder from the gas flow such that the recovered powder is returned to the hopper 110.

The exhaust manifold 115d further comprises an inlet 115e for feeding powder to the system.

An advantage of the powder bed fusion apparatus is that gas-borne powder, the excess powder and the recovered powder are all conveyed back to the hopper 110 for reuse using the same conveying mechanism, which is also used for generating the gas knife. A separate conveying system in addition to the gas circuit is not required as the gas flow itself is used for conveying powder to the hopper. Use of this system in conjunction with a mechanical manipulator 105 provides for automation of the recovery of powder from the powder bed 123 to the hopper 110.

Furthermore, powder is returned to the hopper 110 without removing the powder from the inert atmosphere mitigating problems with systems that remove powder from the machine, for example in removable build sleeves, in that the powder needs to be returned to the powder bed fusion apparatus without exposure to air. However, in a further embodiment, powder separated out by the cyclone 119 is deposited into a container separate to the hopper 110 used for dosing powder such that the powder can be checked before use in a subsequent build. For example, it may be desirable to check the powder for contamination and/or to determine if the powder has a required particle size distribution. This check of the powder may be carried out with the container remaining on the machine or when the container has been removed from the machine, for example to a powder handling facility. Adjustment to the powder, such as adjustment to the particle size distribution may also be carried out on or off the machine, for example by mixing the powder in the container with powder provided from another source. This mixed powder may then be returned to the hopper 110 of the powder bed fusion apparatus for use in a subsequent build.

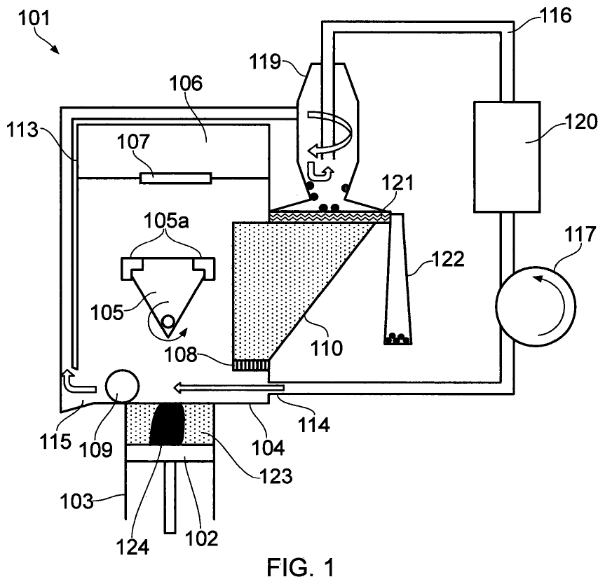

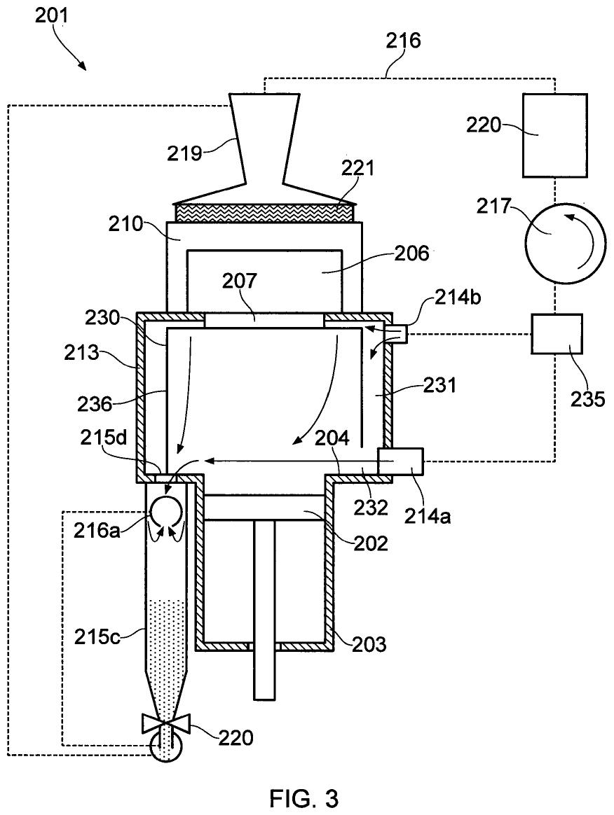

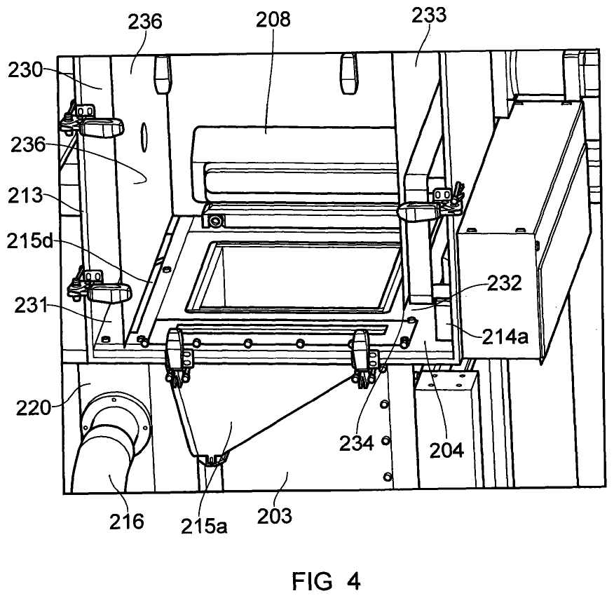

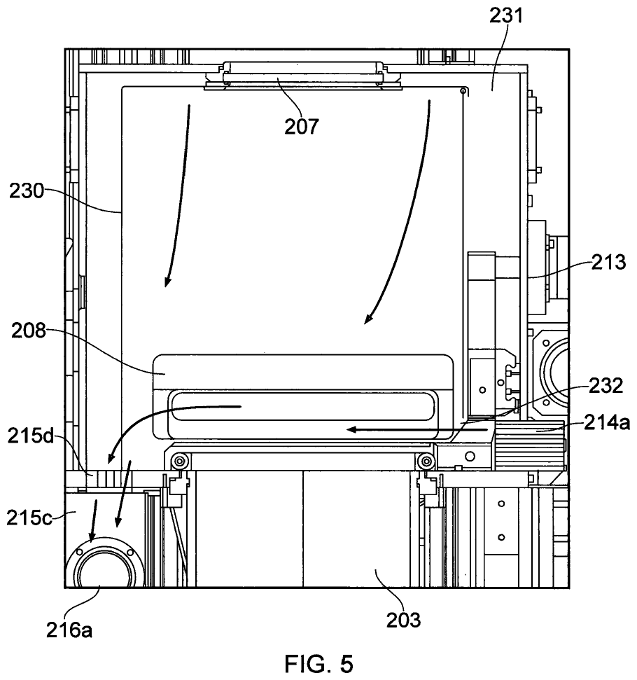

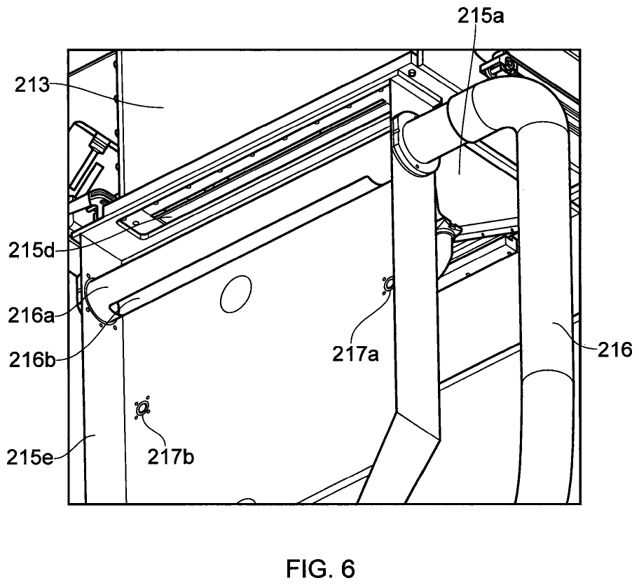

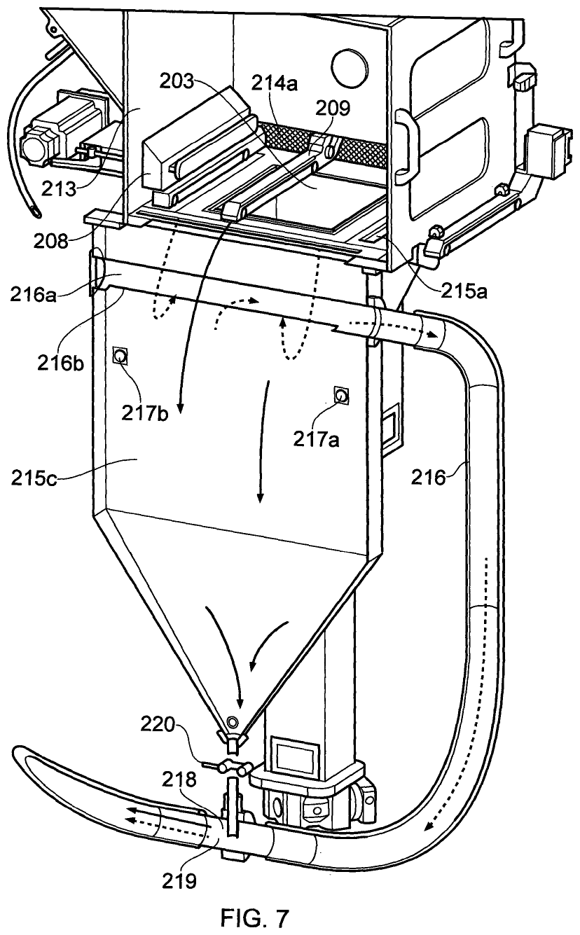

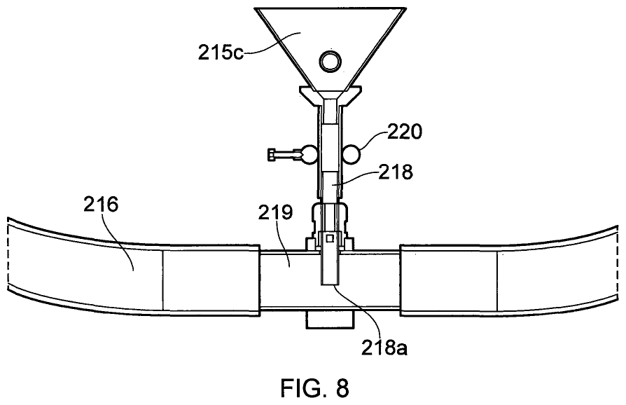

A further embodiment of the invention will now be described with reference to FIGS. 3 to 8. The same reference numerals but in the series 200 are used to refer to features of this further embodiment that correspond to features of the previous embodiment described with reference to FIGS. 1 and 2. Only features of the further embodiment that differ from the embodiment described with reference to FIGS. 1 and 2 will be described below. For the remaining features, reference is made to the above description of these features made with reference to FIGS. 1 and 2.

In the further embodiment, an insert 230 is provided in the build chamber 213 to form a plenum chamber 231 between an outer surface of the insert 230 and the inner surface of the build chamber 213. A top wall of the insert 230, which defines a ceiling, comprises an array of apertures therein (not shown) for allowing gas to flow from the plenum chamber 231 into the central, major volume enclosed by the build chamber 213 and the insert 230. Sidewall 233 of the insert 230 has a lower end 234 that is spaced from a floor/lower surface 204 of the build chamber 231 to define a gap 232 for high velocity gas, delivered through lower gas nozzle 214a to flow across the working surface/powder bed. An upper gas inlet 214b delivers gas into an upper region of the plenum chamber 231.

A flow regulator 235 controls the flow of the inert gas to the two gas inlets 214a and 214b.

In this embodiment, the gas exhaust/opening 215d is provided in a floor (processing plate) 204 of the build chamber 230 for receiving both gas and powder wiped from the powder bed and/or build platform 102. A sidewall 236 of the insert 230 extends to the floor 104 to intersect the gas exhaust 215d such that particles carried to the exhaust/opening 215d by the gas flow and powder displaced to the exhaust/opening 215d by the wiper 209 are carried into/fall into the gas exhaust 215d. Like the first embodiment, two overflow channels (only one 215a is shown) are provided either side the build sleeve 203 in the direction of movement of the wiper 209 for collecting excess powder. The exhaust 215d and overflow channels 215a are connected to a collection hopper 215c.

Extending into a top section of the collection hopper 215c is a gas conduit 216a. In this embodiment, the gas conduit 216a extends across the entire width of the collection hopper 215c. The gas conduit comprises a pipe having a downwardly facing aperture 216b. In this way, the gas flow is sucked into the gas conduit 216a through the aperture 216b (as indicated by the dotted arrows) whilst the majority of the powder particles fall into a lower section of the collection hopper 215c (as indicated by the solid arrows). Accordingly, gas flow is not inhibited by powder collected in the collection hopper 215c (an upper surface of the powder collected in the collection hopper remaining below the aperture 216b).

Powder from the overflow channels 215a, 215b flows into the collection hopper 215c through inlets 217a and 217b.

A bottom of the hopper 215c leads to a feed pipe 218 for feeding the powder back into the gas flow circuit 216. The feed pipe 218 extends into a gas conduit pipe 219 of the gas circuit 216 such that an outlet 218a of the feed pipe 218 is located within the gas conduit pipe 219. Preferably the outlet 218a is located such that powder dispensed from the outlet 218a can form a heap in the conduit pipe 219, which will eventually block the outlet 218a before filling the pipe with powder. In this way, gas can be introduced into the conduit pipe 219 to be entrained in the gas flow but is prevented from filling the pipe and blocking the conduit pipe 219.

A valve 220 is actuatable to control the rate of powder flow though the feed pipe 218. The valve 220 comprises a clamp that can be adjusted to constrict the feed pipe 218 to varying degrees. The clamp may be manually operable or motorised such that it can be adjusted in process under the control of a controller (not shown).

Like the previous embodiment, the powder entrained in the gas flow is carried to a cyclone, which separates the powder from the gas flow and deposits the powder onto a sieve 221. The sieve 221 separates out the oversized particles, with the remaining in powder dropping into dispense hopper 210 for use in the build. The gas is then recirculated back to lower and upper inlet nozzles 214a and 214b to generate the gas flow through the build chamber 213. In this way, the same gas flow circuit is used for generating the gas flow through the build chamber 213 and for transporting the powder to the dispense hopper 210.

At the end of a build, the part is raised up by the build platform 202 out of the build sleeve 203. Like the first embodiment, the apparatus may further comprise a mechanical manipulator (not shown) arranged to engage with a build substrate, to which the object is attached, to tilt the object in a raised position above the working plane such that powder is freed from the object and deposited at a location above the working plane and into the build volume. During freeing of unconsolidated powder from the object (with or without a mechanical manipulator), the gas flow from lower inlet nozzle 214a may be increased and the gas flow through upper inlet nozzle 214b reduced or even stopped altogether in order to increase the velocity of gas from nozzle 214a. This high velocity gas may act to blow powder from the object. Rather than adjusting the pump speed or in addition to adjusting the pump speed, the flow regulator 235 is operated to alter the ratio of gases flowing to the lower and upper gas nozzles 214a, 214b. In addition or alternatively, the lower gas nozzle 214a may comprise a shutter (not shown) for reducing a size of the aperture(s) in the lower gas flow nozzle 214a, thereby increasing the gas flow therefrom.

Modifications and alterations may be made to the above described embodiments without departing from the scope of invention as defined in the claims. For example, powder may be displaced to the exhaust channels 115a. 115b using vibrations of the build platform 102 and/or the surfaces 104 surrounding the build platform 102.

1. A powder bed fusion apparatus comprising a build chamber, a build platform in the build chamber for supporting a powder bed, a layer formation device for forming layers of powder to form the powder bed, a scanner for scanning an energy beam across the powder bed to fuse the powder and a gas circuit for forming a gas flow across the powder bed, the gas circuit comprising a separator for separating particles from gas in the gas circuit, a nozzle for propelling gas into the build chamber and an exhaust for extracting gas from the build chamber and delivering the gas to the separator, the exhaust comprising an exhaust channel or opening located for receiving powder wiped from the powder bed and/or build platform.

2. A powder bed fusion apparatus according to claim 1, wherein the layer formation device forms layers of powder in a working plane and the exhaust channel or opening is located at or below the working plane.

3. A powder bed fusion apparatus according to claim 1, wherein the exhaust channel or opening is located such that powder displaced from the powder bed falls and/or flows into the exhaust channel or opening.

4. A powder bed fusion apparatus according to claim 1, comprising mechanical means for wiping the powder into the exhaust channel or opening.

5. A powder bed fusion apparatus according to claim 4, wherein the layer formation device comprises a wiper for spreading each layer and the exhaust channel or opening is located such that the wiper pushes powder from the powder bed into the exhaust channel or opening.

6. A powder bed fusion apparatus according to claim 5, wherein the wiper moves in a direction perpendicular to a gas flow direction through the build chamber.

7. A powder bed fusion apparatus according to claim 5, wherein the exhaust comprises a first exhaust channel or opening located to be one side of the powder bed and a second exhaust channel or opening located to be another side of the powder bed.

8. A powder bed fusion apparatus according to claim 1, wherein a bottom of the exhaust channel is angled relative to the horizontal such that powder flows along the exhaust channel to be carried away by the gas flow in the gas circuit.

9. A powder bed fusion apparatus according to claim 8, wherein an angle of the bottom of the channel is greater than an angle of repose of the powder.

10. A powder bed fusion apparatus according to claim 1, wherein the exhaust comprises an opening that extends above the powder bed for generating the gas flow across the powder bed.

11. A powder bed fusion apparatus according to claim 1, wherein the layer formation device comprises a hopper from which powder is dosed in a controlled manner to be formed into the layers, wherein the separator is located above the hopper such that powder falls from the separator into the hopper.

12. A powder bed fusion apparatus according to claim 11, wherein the hopper is arranged to dose powder into the build chamber from above a working plane in which the layer formation device forms layers of powder and powder is conveyed from the exhaust up to the separator by the gas flow.

13. A powder bed fusion apparatus according to claim 1, wherein the separator comprises a cyclone separator.

14. A powder bed fusion apparatus according to claim 1, comprising an end effector in the build chamber to pick the object up and elevate it above the build platform such that powder freed from the object can be pushed by the wiper or by an operator from the build platform into the exhaust channel or opening.

15. A powder bed fusion apparatus according to claim 1, comprising a collection hopper for collecting powder wiped from the powder bed and/or build platform into the exhaust, the collection hopper comprising a gas outlet in an upper section thereof and a powder outlet below the gas outlet; a gas conduit connected to the gas outlet for transporting gas back to the nozzle, the powder outlet arranged to feed powder into the gas conduit such that the powder is entrained in the gas flow and transported to the separator.
